(19) United States
(12) Patent Application Publication
(10) Pub. No.: US 2014/0130628 A1
(43) Pub. Date: May 15, 2014

(54) ACCESSORY GEARBOX FOR A GAS TURBINE

(71) Applicants: Vincent Abousleiman, Colombes (FR); Romaric Fritz, La Garenne Colombes (FR)

(72) Inventors: Vincent Abousleiman, Colombes (FR); Romaric Fritz, La Garenne Colombes (FR)

(73) Assignee: HISPANO-SUIZA, Colombes (FR)

(21) Appl. No.: 14/129,775

(22) PCT Filed: Jun. 27, 2012
(86) PCT No.: PCT/FR12/51486

§ 371 Date: Jan. 13, 2014

(30) Foreign Application Priority Data
Jun. 28, 2011 (FR) 11 55771

(51) Int. Cl. F16H 57/021

(52) U.S. Cl. CPC F16H 57/021
USPC 74/412 R

(57) ABSTRACT

An accessory gearbox for a gas turbine, the gearbox including a front lateral face and a rear lateral face opposite from the front face and a peripheral rim closing the box, and at least one mounted gear train including a plurality of gearwheels meshing together, each gearwheel being carried by a central shaft held at each of its two ends by a respective rolling bearing, the rolling bearings of at least one of the two ends being fastened together on at least one perforated plate attached to the peripheral rim.

### BACKGROUND OF THE INVENTION

The present invention relates to the general field of gas turbines, and more particularly it relates to a gearbox for driving accessories of a gas turbine.

The field of application of the invention is that of gas turbines for airplane or helicopter engines, and also for auxiliary power units (APUs).

In general, an airplane or helicopter gas turbine engine includes a gearbox for driving a plurality of accessories of the turbine or for driving auxiliary equipment, such as in particular various pumps for producing hydraulic energy, for feeding fuel, for lubrication, electricity generators for producing electrical power, etc. Such an accessory gearbox is commonly referred to by the abbreviation AGB.

In known manner, an AGB contains one or more gear trains, each made up of a plurality of gearwheels that are driven in rotation by a power transmission shaft, which shaft is coupled to a shaft of the turbine. As shown by way of example in application FR 2 928 696 in the name of the Applicant, each accessory is generally mounted against one of the lateral faces of the gearbox and includes a drive shaft that couples with one of the gearwheels of the gear train(s). In addition to this accessory support function, these lateral faces also perform a bearing support function, a sealing function, or indeed a lubrication function.

These multiple functions performed by the two lateral faces of the box end up causing these boxes to be parts that are particularly complex and difficult to fabricate as a result of combining large dimensions with tight fabrication tolerances. Furthermore, gearboxes for driving accessories are presently made essentially by using a lengthy and expensive foundry process that it is important to be able to decrease considerably.

### OBJECT AND SUMMARY OF THE INVENTION

A main object of the present invention is thus to mitigate such drawbacks by proposing a gas turbine AGB that makes it possible to simplify considerably the shape of the casings and to make them easy to fabricate with the machining means that are conventional in aviation.

This object is achieved by an accessory gearbox for a gas turbine, the gearbox having a front lateral face and a rear lateral face opposite from said front face and having a peripheral rim closing the box, and in which there is mounted at least one gear train made up of a plurality of gearwheels meshing together, each gearwheel being carried by a central shaft held at each of its two ends by a respective rolling bearing, the gearbox being characterized in that said rolling bearings of at least one of said two ends are fastened together on at least one perforated plate attached to said peripheral rim.

The separation of the function of supporting the bearings and/or accessories as performed by this perforated plate from the other functions of the front lateral face enables that face to be reduced to no more than a cover serving solely to provide a sealing or lubrication function. This cover can then be made very easily by machining using conventional tools and a lightweight material, which also considerably improves metallurgical quality.

In an advantageous provision, said at least one perforated plate presents the form of a lattice in order to limit its weight. Said at least one perforated plate may also form an accessory support.

Advantageously, said attachment is performed by pegs or analogous fastener means passing through said at least one perforated plate and through bosses formed in said peripheral rim.

Preferably, each of said rolling bearings is fastened to said at least one perforated plate by screws or any other analogous means passing through the outer ring of the rolling bearing.

Advantageously, said peripheral rim is terminated by a collar pierced by multiple holes enabling it to be fastened to a peripheral portion of said front face.

Preferably, said peripheral portion is fastened by a plurality of screws, of bolted flanges, or of any other equivalent means.

### BRIEF DESCRIPTION OF THE DRAWING

Other characteristics and advantages of the present invention appear from the following description made with reference to the accompanying drawing which shows an embodiment having no limiting character. In the figures:

FIG. 1 is a fragmentary inside view of a gearbox for driving accessories of the invention; and

FIG. 2 is a section view of the FIG. 1 gearbox showing the connection with the various accessories.

### DETAILED DESCRIPTION OF EMBODIMENTS

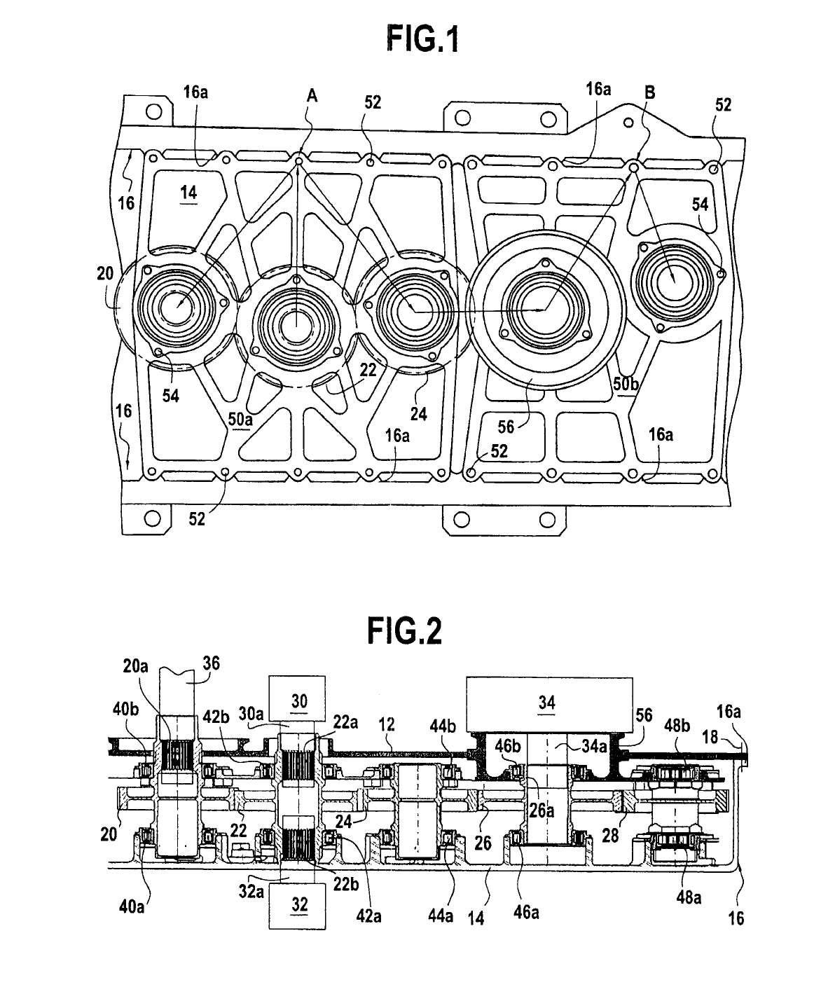

FIG. 1 shows an inside view of an example of an airplane engine gas turbine AGB 10 of the invention that is also shown in section in FIG. 2. Naturally, the invention applies equally well to helicopter engine gas turbines, and to APUs.

This AGB is conventionally a substantially rectangular box of “banana” or “haricot bean” shape, with a front lateral face 12 and a rear lateral face 14 opposite from the front face and having a raised peripheral rim 16 that is terminated by a collar 16A pierced by multiple holes enabling it to be fastened to the peripheral portion of the front face 12 (e.g. by screws, bolted flanges, or any other equivalent means 18). This box houses one or more gear trains made up of gearwheels (20, 22, 24, 26, 28) meshing together and extending parallel to the lateral faces and conventionally having the function of driving a plurality of accessories (e.g. 30, 32, 34) in rotation.

Each of the accessories is mounted on one of the lateral faces of the box. Each accessory also has a drive shaft 30a, 32a, 34a that is mounted in internal fluting 22a, 22b, 26a of the shaft carrying the corresponding gearwheel in order to be driven thereby. It should be observed that in the example shown, the two accessories 30 and 32 have their respective drive shafts 30a, 32a coupled in rotation with the same gearwheel 22 and they are mounted against different lateral faces of the box.

A power transmission shaft 36 (shown in part in FIG. 2 emerging from the front lateral face 12 of the box, substantially perpendicularly relative thereto) takes mechanical power from a shaft of the turbine (not shown in figures) in order to transmit that power to the various gearwheels of the gear train. For this purpose, the power transmission shaft is coupled to rotate with the gear train by means of fluting 20a internal to the gearwheel 20.

According to the invention, each shaft carrying a gearwheel is held at each of its ends by a rolling bearing 40a, 40b, 42a, 42b, 44a, 44b, 46a, 46b, 48a, 48b, and the bearings on one of these two ends (the end facing the front lateral face) are fastened together to at least one bearing support 50a, 50b attached to the peripheral rim 16 of the rear lateral face. By way of example, this attachment may be performed by means of pegs or of analogous fastener means 52 passing through the bearing support 50a, 50b and through bosses 16a formed in the peripheral rim 16. The bearing support is constituted by a metal plate that is preferably perforated like a lattice in order to limit its weight. Each of the bearings is fastened to the bearing support, e.g. by screws 54 passing through the outer rings of the bearings.

In a variant implementation, this perforated plate forming a bearing support may also incorporate an accessory support 56 arranged circumferentially about a gearwheel shaft, thereby also performing this second support function. This eliminates any misalignment that might be present on the fluting of the accessories in question, and since the structural support functions of the box disappear, it can be made as light as possible in order to optimize its weight.

The use of such bearing supports, each of which is of reasonable size (about 50 centimeters (cm)) avoids the need for functional dimensioning over long distances (an AGB commonly measures 150 cm) since this dimensioning can then be performed little by little relative to references taken on the bearing supports. Thus, as shown in FIG. 1, the dimensioning of the positions for the rolling bearings takes place from a first reference point A on the first bearing support 50a and then continues on the second bearing support 50b relative to the second reference point B. In this manner, the chains of dimensions can be caused to lie within the ranges of accuracies and tolerances that are usual in machining, which increases the feasibility of the box. The positioning of the rolling bearings is under better control.

Since these bearing supports are fastened to the box by means of bosses occupying little space, the machining of the rear lateral face 14 and of its peripheral rim 16 can be performed easily, even in the zones masked under the bosses. This machining is made that much easier by the box being in the form of two easily-separable half-shells (as applies in particular when they are fastened together by a flange bolted between the lateral faces), with one of the half-shells forming a cover that therefore has no bearing support function.

1-7. (canceled)

8. An accessory gearbox (AGB) for a gas turbine, comprising:
a front lateral face and a rear lateral face opposite from the front face;
a peripheral rim closing a box; and
at least one mounted gear train including a plurality of gearwheels meshing together, each gearwheel being carried by a central shaft held at each of its two ends by a respective rolling bearing,
wherein the rolling bearings of the gearbox at at least one of the two ends are fastened together on at least one perforated plate attached to the peripheral rim.

9. An AGB according to claim 8,
wherein the at least one perforated plate is in a form of a lattice to limit its weight.

10. An AGB according to claim 8, wherein the at least one perforated plate also forms an accessory support.

11. An AGB according to claim 8, further comprising pegs or fastener means passing through the at least one perforated plate and through bosses formed in the peripheral rim.

12. An AGB according to claim 8, wherein each of the rolling bearings is fastened to the at least one perforated plate by screws or fastener means passing through an outer ring of the rolling bearing.

13. An AGB according to claim 8, wherein the peripheral rim is terminated by a collar pierced by multiple holes enabling the peripheral rim to be fastened to a peripheral portion of the front face.

14. An AGB according to claim 13, wherein the peripheral portion is fastened by a plurality of screws, or bolted flanges, or fastener means.
